(19) United States
(12) Patent Application Publication
(10) Pub. No.: US 2002/0156172 A1
(43) Pub. Date: Oct. 24, 2002

(54) Melt flow in polymers by high molecular weight fischer-tropsch wax addition

(76) Inventors: William Berlin Genetti, Baton Rouge, LA (US); Loren Leon Ansell, Baton Rouge, LA (US); Daniel Francis Ryan, Baton Rouge, LA (US); Jack Wayne Johnson, Clinton, NJ (US); Eric Bart Sirota, Flemington, NJ (US); Paul Joseph Berlowitz, Glen Gardner, NJ (US)

Correspondence Address: EXXONMOBIL RESEARCH AND ENGINEERING COMPANY, P.O. Box 900, Annandale, NJ, 08801-0900, US

(21) Appl. No.: 10/077,608

(22) Filed: Feb. 15, 2002

Related U.S. Application Data
(60) Provisional application No. 60/272,734, filed on Mar. 2, 2001.

(51) Int. Cl. C08K 5/01

(52) U.S. Cl. 524/489

(57) ABSTRACT

The melt flow of a polymer or mixture of polymers is increased by mixing the polymer with a Fischer-Tropsch wax yet the flexural strength and hardness of the polymer is not significantly decreased.

This application is a Provisional of U.S. Serial No. 60/272,734 filed Mar. 2, 2001.

### FIELD OF INVENTION

The present invention relates generally to improvements in polymer processing. More particularly the invention relates to polymer compositions having enhanced melt flow while retaining the flexural strength and hardness of the base polymer by incorporating a novel processing aid in a base polymer.

### BACKGROUND OF INVENTION

The use of processing aids in molding, extruding, calendaring, sheet forming or otherwise fabricating shaped articles from solid polymers is of utmost practical importance. In forming shaped articles by extrusion technique, for example, processing aids are added to the base polymer to increase the melt flow index of the polymer which decreases the energy required to extrude the polymer and permits increased throughput, thereby improving the economics of the extrusion process. On the other hand, processing aids often detrimentally effect the mechanical properties of the articles fabricated from the polymer. Thus polymer fabricators are continually in need of new and improved processing aids that have less effect on the mechanical properties of the finished article. Indeed, it would be desirable to have available to the art techniques for improving the melt flow index of a polymer while retaining the flexural strength and hardness of the polymer.

### SUMMARY OF INVENTION

One aspect of the invention comprises a polymer composition having a major amount of base polymer or mixture of polymers blended with a Fischer-Tropsch derived wax (F-T wax) in an amount sufficient to enhance the melt flow index of the base polymer while substantially retaining the flexural strength and toughness of the base polymer or mixture of polymers.

Another aspect of the invention comprises a method for improving the melt flow of a polymer or mixture of polymers while substantially retaining the flexural strength and hardness of the polymer or mixture of polymers by mixing a Fischer-Tropsch derived wax (F-T wax) with the polymer or mixture of polymers in an amount sufficient to enhance the melt flow of the polymer or polymers while substantially retaining their flexural strength and hardness.

### BRIEF DESCRIPTION OF THE DRAWINGS

FIGS. 1 to 3 are bar graphs demonstrating the beneficial effect of the use of F-T wax as a processing aid in accordance with the present invention.

### DETAILED DESCRIPTION OF INVENTION

The base polymers employed in the composition of the present invention are thermoplastic polymers or mixtures thereof suitable in forming rigid shaped articles by applying heat, pressure or both to the polymer or polymer mixtures. Examples of such process techniques include injection molding, blow molding, extrusion, calendaring, sheet forming and the like. Examples of suitable polymers include polyolefins, nylon, polyesters and polycarbonates. Particularly preferred polymers are semicrystalline polyolefins such as high density polyethylene, ultra high molecular weight polyethylene, polypropylene and the like.

The composition of the invention comprises a major amount of the base polymer. For example the base polymer typically will comprise from about 80 wt % to about 99 wt % of the total composition.

Included in the composition is a Fischer-Tropsch derived wax.

The Fischer-Tropsch process is well known to those skilled in the art. See for example, U.S. Pat. Nos. 5,348,982 and 5,545,674, which are incorporated herein by reference. Typically the Fischer-Tropsch process involves the reaction of a synthesis gas feed comprising hydrogen and carbon monoxide in the presence of a Fischer-Tropsch catalyst. Typical catalysts include a supported or unsupported Group VIII, non-noble metal (e.g., Fe, Ni, Co) with or without a promoter (e.g., ruthenium, rhenium, hafnium, zirconium, titanium). The primary product of the Fischer-Tropsch process is mainly paraffinic synthetic crude. The waxy component of the crude, i.e., the F-T wax, contains a high proportion of normal paraffins. In the practice of the present invention the F-T wax used is a 1000° F.+ boiling fraction with a carbon number of about C₄₀ to about C₁₀₀, preferably a 1100° F.⁺ boiling fraction with a carbon number between about C₅₄ and about C₁₀₀ and more preferably a 1300° F.+ boiling fraction with a carbon number between about C₆₇ and about C₁₀₀.

The F-T wax is blended with the base polymer or mixture of polymers by blending techniques well known in the art. For example the polymer and F-T wax may be blended in a Banbury mixer.

The amount of F-T wax included in the compositions of the invention is that amount sufficient to enhance the melt flow of the base polymer without substantially decreasing the flexural strength and hardness of the base polymer. Thus sufficient F-T wax is added to increase the melt index of the polymer while retaining about 93% of the Rockwell Hardness and about 92% of the flexural strength of the polymer.

Typically the composition will contain from about 1 to about 20 wt % of the F-T wax.

### EXAMPLES

In the Examples and Comparative Examples which follow, samples were prepared from four different processing aids by blending a specific amount of the aid with a commercially available, additive free, high density polyethylene (HDPE). Two of the additives were F-T waxes of this invention having the properties shown in Table 1 below.

TABLE 1

| | | |
|---|---|---|
| | 1100/1300° F. | 1300+° F. |
| Characterization | Boiling Range | Boiling Range |
| Technique | Fischer-Tropsch Wax | Fischer-Tropsch Wax |
| GCD⁽¹⁾ [° F.] | 968.5/1096.5.0/1255.6 | 1009.0/1179.6/1284.6 |
| (0.5)/(50)/(99.5) [wt %] | | |
| Average Carbon Number | 54.5/54.7/52.4 | 67.2/76.8/71.1 |
| (Cₙ) | | |
| (GC)⁽²⁾/(NMR)⁽³⁾/ | | |
| (FD-MS)⁽⁴⁾ | | |
| Average Molecular | 736 | 998 |
| Weight [g/mol] | | |
| Molecular Weight Range | 493-1065 | 555-1570 |
| [g/mol] | | |
| Melting/Congealing | 210 | 228 |
| Point [° F.] | | |

⁽¹⁾GCD = gas chromatograpic distillation
⁽²⁾GC = gas chromotography
⁽³⁾NMR = nuclear magnetic resonance
⁽⁴⁾ED-MS = field desorption mass spectroscopy

Of the other two processing aids one was a fully refined petroleum wax with a melting point of 144° F. and an oil content less than 0.1%-mass sold by Exxon Mobil Corporation, Baton Rouge, La., under the trade name Paravan 142. The other was a low density polyethylene with a melting point of 115° C. and melt index of 55 g/10-min. sold by the Aldrich Company of Milwaukee, Wis.

Each of the processing aids were blended with the HDPE in a 2 pound Banbury melt mixer at 5 and 10 wt % levels to produce a uniform dispersion in the polymer pellets. Plaques for each HDPE blend were also prepared by compression molding for testing as described hereinafter.

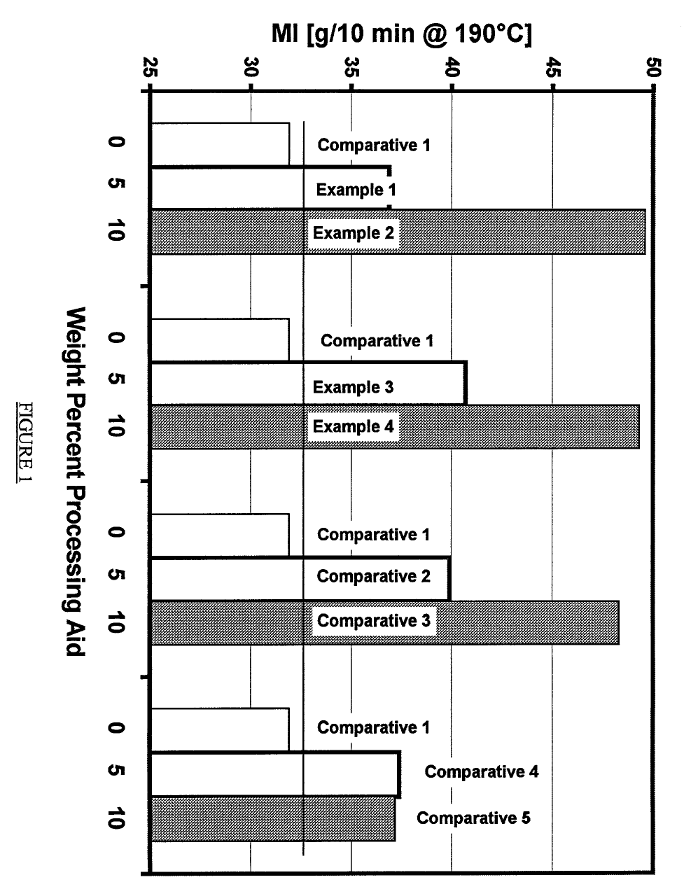

The melt index (MI) of the pellets was measured by ASTM D-1238 at 190° C. and 2.16 kg for 10 minutes. The MI of the HDPE alone was also measured for comparative purposes. The results are shown in FIG. 1. As can be seen from FIG. 1 all of the processing aids increased the MI.

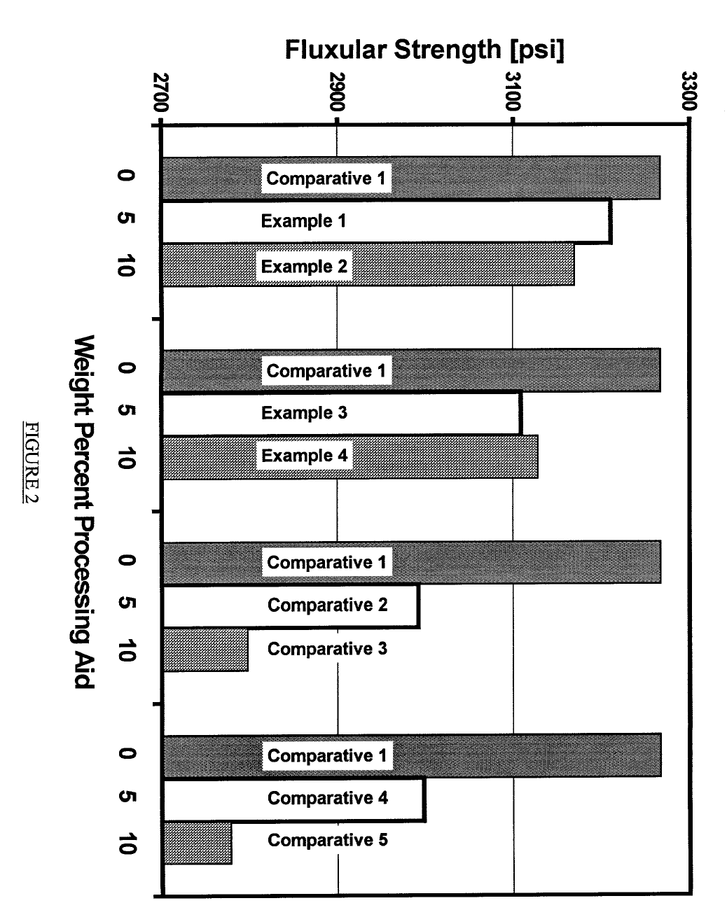

The flexural strength of each sample plaque was measured according to ASTM-790 using an Instron Series #C 8658 instrument with a crosshead speed of 0.05 inch per minute. The results are shown in FIG. 2. As can be seen, the flexural strength (the force required to break in a three bend test) was much higher for blends with the F-T wax.

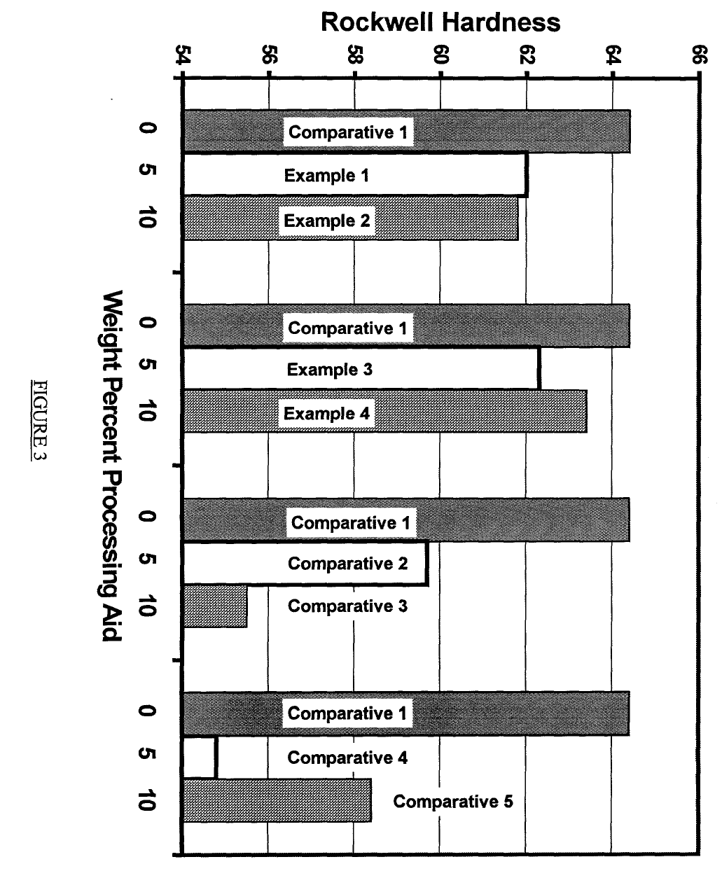

The Rockwell hardness for each sample plaque was determined according to ASTM D-785 with a minor load of 10 kg and a major load of 60 kg. The results are shown in FIG. 3. As can be seen, the hardness of both F-T wax blends was superior to that of blends with the other processing aids.

What is claimed is:

1. A polymer composition comprising:
a major amount of a base polymer or mixture of polymers; and
a Fischer-Tropsch derived wax in an amount sufficient to enhance the melt flow index of the polymer or mixture while substantially retaining the flexural strength and hardness of the polymer.

2. The composition of claim 1 wherein the base polymer is a thermoplastic polymer suitable for forming rigid shaped articles by applying at least one of heat and pressure.

3. The composition of claim 2 wherein the base polymer is a polyolefin.

4. The composition of claim 3 wherein the amount of wax is sufficient to increase the melt index of the polymer while retaining about 93% of the Rockwell Hardness and about 92% of the flexural strength of the polymer.

5. The composition of claim 4 wherein the F-T wax is selected from the group consisting of a 1000° F. boiling fraction with a carbon number of from about C₄₀ to about C₁₀₀, an 1100° F.+ boiling fraction with a carbon number of from about C₅₄ to about C₁₀₀ and a 1300° F.+ boiling fraction with a carbon number of about C₆₇ to about C₁₀₀.

6. The composition of claim 1 wherein the F-T wax comprises form about 1 to about 20 wt % of the total composition.

7. A method for improving the metal flow of a thermoplastic polymer suitable for forming into rigid shaped articles by applying at least one of heat and pressure comprising blending the polymer with a F-T wax in an amount sufficient to increase the melt flow index of the polymer while substantially retaining the flexural strength and hardness of the polymer.

8. The method of claim 7 wherein the F-T wax is blended in an amount ranging from about 1 to about 20 wt %.

9. The method of claim 7 wherein the amount of wax is sufficient to increase the melt index of the polymer while retaining about 93% of the Rockwell Hardness and about 92% of the flexural strength of the polymer.

10. The method of claim 8 or 9 wherein the F-T wax is selected from the group consisting of a 1000° F.+ boiling fraction having a carbon number of from about C₄₀ to about C₁₂₀, an 1100° F. boiling fraction having a carbon number of from about C₅₄ to about C₁₀₀, and a 1300° F.+ boiling fraction having a carbon number of from about C₆₇ to about C₁₀₀.
